(19) United States
(12) Patent Application Publication
(10) Pub. No.: US 2004/0095754 A1
(43) Pub. Date: May 20, 2004

(54) Candle lamp

(76) Inventor: Yuan-Shun Hsu, Chu-Pei City (TW)

Correspondence Address: BIRCH STEWART KOLASCH & BIRCH, PO BOX 747, FALLS CHURCH, VA, 22040-0747, US

(21) Appl. No.: 10/298,684

(22) Filed: Nov. 19, 2002

(51) Int. Cl. F21L 19/00

(52) U.S. Cl. 362/161

(57) ABSTRACT

An improved candle lamp includes a lamp shade coupling with a lamp holder. The lamp shade has a periphery mating the periphery of the lamp holder. The lamp shade has one end forming a coupling section to engage with the lamp holder. Light may pass through the lamp shade and refract and scatter around to foster a warm and soothing atmosphere for houses and living quarters.

### FIELD OF THE INVENTION

The present invention relates to an improved candle lamp that imitates a candle profile to foster warm and soothing atmosphere for houses and living quarters.

### BACKGROUND OF THE INVENTION

Conventional candle lamps generally have a candle-like lamp holder and a flame-like lighting bulb. When energized with electricity, the candle lamp projects light to help decorating the house and living quarters to foster warm and soothing atmosphere.

However, after the lighting bulb is coupled with the lamp holder, the lighting bulb is exposed to the outside environment. It is prone to hit external articles and get damaged. Moreover, the bare lighting bulb is easy to gather dusts and result in dimmer illumination. And the high temperature on the surface of the lighting bulb also may burn people, especially children. Hence there are many concerns and risks related to the use of conventional candle lamps.

Furthermore, conventional candle lamps do not have lamp shades to refract or filter light. Light emitting from the light bulb becomes irritating to human eyes and is too strong, and the effect of fostering pleasant indoor atmosphere is not desirable.

### SUMMARY OF THE INVENTION

Therefore the primary object of the invention is to resolve the foregoing disadvantages. The invention provides a novel design for candle lamps that is safer to transport and use. A lamp shade is provided to couple with the lamp holder. The lamp shade is formed with different shapes, colors and convex, concave or carved out surfaces, and may have patterns, floral traces and curved lines formed thereon. The lamp shade not only protects the lighting element from being hit and damaged, it also enables the light be refracted or filtered, or to pass through the carved out surface to scatter around to generate a soft and soothing atmosphere.

Another object of the invention is to provide a lamp shade for holding essence. Heat generated by the lighting bulb can disperse fragrance to achieve the effect of producing aroma without flame. It avoids the smearing occurred to conventional practices of dropping the essence on the lamp shade (generally made from fabric) for preventing burning the essence.

Yet another object of the invention is to provide a clip at the bottom of the lamp holder to enable the candle lamp be clipped on a wall or furniture to improve convenience.

In order to achieve the foregoing objects, the candle lamp of the invention includes a lamp holder and a lamp shade. The lamp shade has a periphery mating the periphery of the lamp holder. The lamp shade has one end formed a coupling section to engage with the lamp holder. Light emitted from lighting element may be refracted through the lamp shade and scatter around to generate warm and soothing atmosphere in the house and living quarters.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a lamp shade of the invention.

FIG. 2 is a cross section taken along line 2-2 in FIG. 1.

FIG. 3 is a schematic view of the invention in use.

FIG. 4 is a schematic view of a first embodiment of the invention.

FIG. 5 is a schematic view of a second embodiment of the invention.

FIG. 6 is a schematic view of a third embodiment of the invention.

FIG. 7 is a schematic view of a fourth embodiment of the invention.

FIG. 8 is a schematic view of a fifth embodiment of the invention.

### DESCRIPTION OF THE PREFERRED EMBODIMENTS

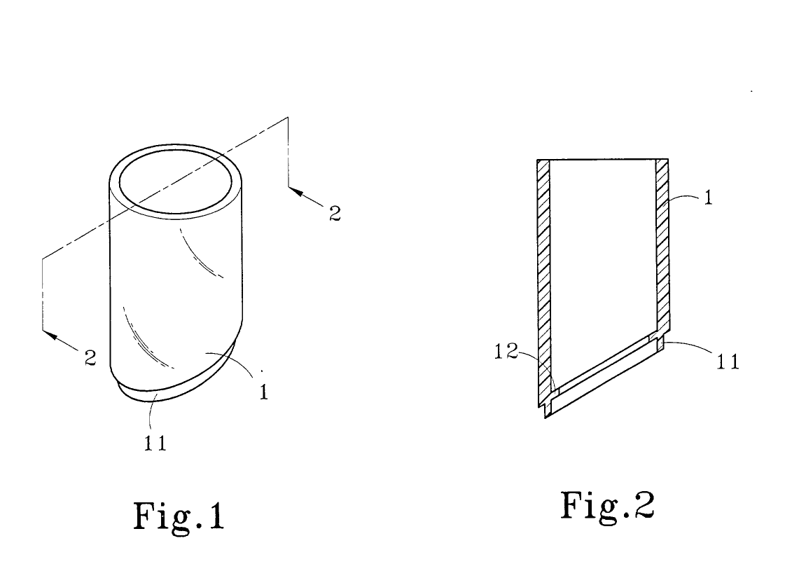

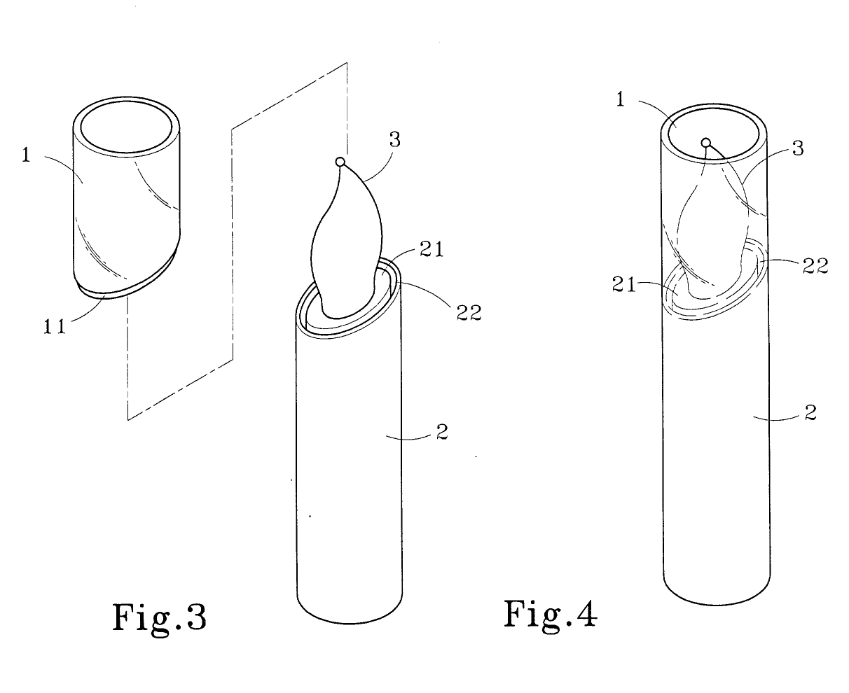

Referring to FIGS. 1,2 and 3, the improved candle lamp of the invention includes a lamp holder 2 coupling with a lamp shade 1. The lamp shade 1 has a periphery mating the periphery of the lamp holder 2. The lamp shade 1 has one end formed a coupling section 11 to engage with the lamp holder 2. Through coupling the lamp shade 1 on the lamp holder 2, light may be refracted through the lamp shade and scatter around to generate warm and soothing atmosphere in the house and living quarters.

The lamp shade 1 has one end formed a coupling section 11. There is a rest section 12 above the coupling section 11.

The holder 2 is formed to imitate the profile of a candle. It has a holding surface 21 corresponding to the coupling section 11 of the lamp shade 1 and a recess 22 to couple with the coupling section 11. There is a lighting element 3 mounted onto the holding surface 21.

The lighting element 3 is a light emitting diode or a lighting bulb formed in the shape of a flame.

The coupling section 11 of the lamp shade 1 is coupled in the recess 22 of the lamp holder 2 with the rest section 12 mounting onto the holding surface 21. When energized with electricity, light is generated and passes through the lamp shade 1 and refracts and scatters around to produce brilliant reflective optical paths. Thus a sensuously pleasant visual effect is created and marginal effect increases. Because of the protection of the lamp shade 1, the lighting element 3 on the lamp holder 2 is less likely to be hit or damaged. The surface of the lighting element 3 also is less likely to gather dusts, and illumination of the lighting element 3 is not affected. Moreover, the lamp shade 1 also can prevent the high temperature generated by the lighting element 3 from hurting users or children.

Refer to FIG. 4 for a first embodiment of the invention. The lamp holder 2 is made by an injection forming process, then a shrink molding process is applied from the bottom of the lamp holder 2 and extended upwards to encase the lamp holder with a transparent shrinking sleeve on the surface of the lamp holder 2. Then the sleeve is shrunk to form a transparent lamp shade 1. After the shrinking is completed, a jutting and indented line may be carved on the location corresponding to the holding surface 21 of the lamp holder 2 to highlight a three dimensional appearance. The lamp shade 1 may cover the outer surface of the lamp holder 2 through an integrated shrink molding to save assembly time and transportation efforts.

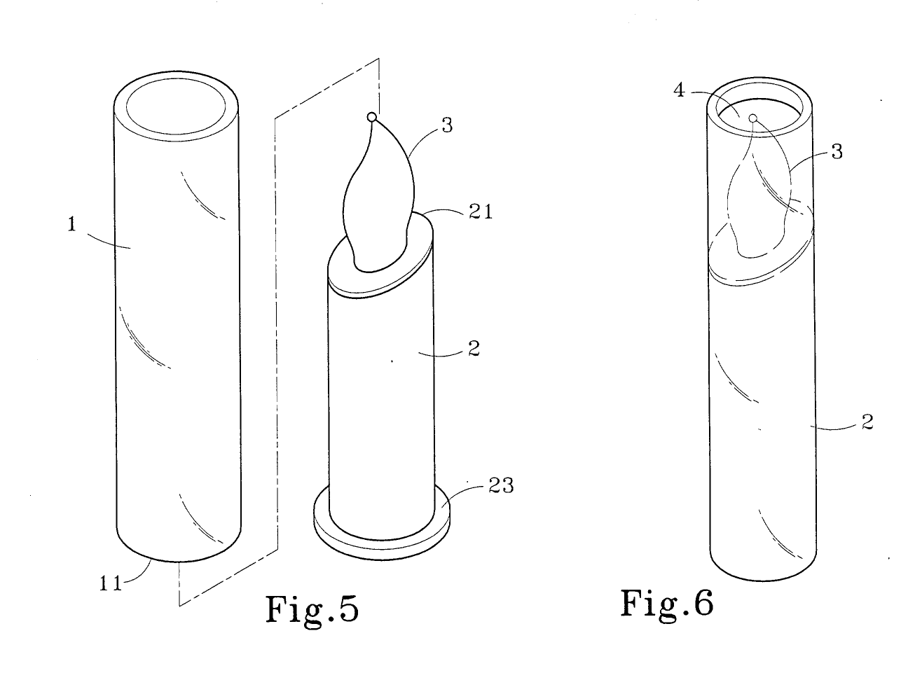

Refer to FIG. 5 for a second embodiment of the invention. The lamp shade 1 may also cover the entire lamp holder 2. The bottom end of the lamp holder 2 may has a retaining section 23 to couple with the coupling section 11 of the lamp shade 1.

Refer to FIG. 6 for a third embodiment of the invention. The top end of the lamp shade 1 may form an indented trough 4 for holding essence. Heat generated by the lighting element 3 when in use disperses the fragrance to produce aroma without flame. It is an improvement over conventional approaches that drop the essence on the fabric lamp shades and often result in smeared lamp shades that are difficult to wash and clean.

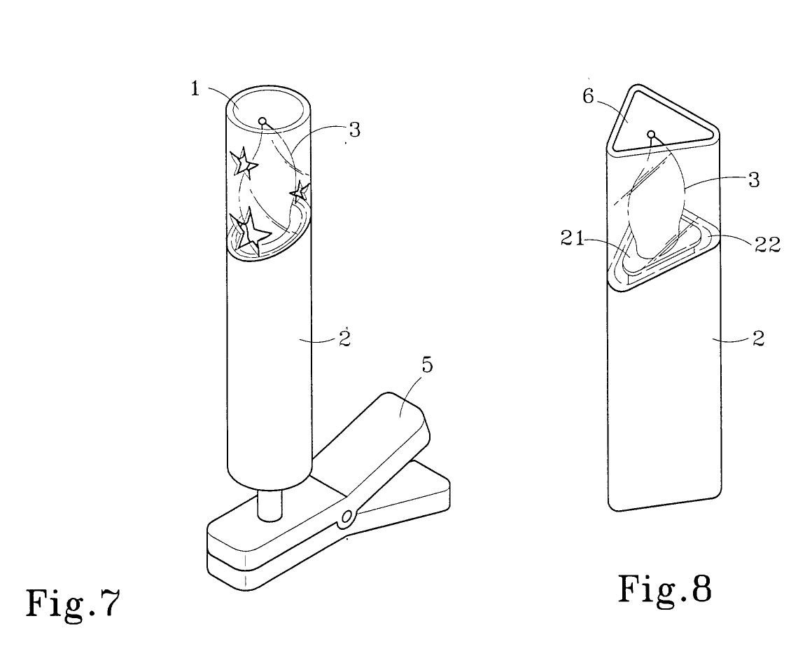

Refer to FIG. 7 for a fourth embodiment of the invention. The surface of the lamp shade 1 may be formed in different shapes or with a carved out surface. The bottom end of the lamp holder 2 may also be fastened to a clip 5 to allow the lamp holder 2 be clipped on a wall or furniture. Light of the lamp may match the environment to achieve desired decorating effect and offer versatile matching choices. In addition, light passing through the carved out surface may help to foster romantic atmosphere for the total ornamental lighting fixtures.

Refer to FIG. 8 for a fifth embodiment of the invention. The periphery of the lamp shade 1 mates the periphery of the lamp holder 2. Such as when the lamp holder 2 is a triangular strut 6, the lamp shade 1 may be an extension of the triangular strut. Or the coupled lamp holder 1 and the lamp shade 1 may become a human figure, an animal figure or a plant.

In addition, the lamp shade 1 may have one open end or two open ends to allow light to project directly through the openings besides refracting through the lamp shade so that radiating light may be produced to create different decorative effect.

Moreover, the lamp shade 1 may be made transparent, translucent, or with smoke surfaces.

Furthermore, the outer surface of the lamp shade 1 may be formed with different patterns, floral traces and curved lines, or convex or concave surface of various shapes with patterns or carved out openings.

Finally, as the lamp shade 1 is spaced from the lighting element 3, lights emitted from the lighting element 3 are refracted repeatedly on the inner wall of the lamp shade 1, and can generate a fuzzy and swaying visual effect. Thus the entire candle lamp emanates a real candle light image and feeling, and can foster a warm and romantic atmosphere.

In summary, by means of the construction set forth above, the invention not only is more convenient to transport, easier to install and safer to use, it also effectively overcomes the disadvantages of the conventional ornamental lights.

What is claimed is:

1. A candle lamp, comprising:
a lamp holder; and
a lamp shade coupled with the lamp holder having a periphery mating the periphery of the lamp holder; and
a coupling section located on one end of the lamp shade to engage with the lamp holder.

2. The candle lamp of claim 1, wherein the lamp holder and the lamp shade are coupled to selectively form a human figure, an animal figure or a plant.

3. The candle lamp of claim 1, wherein the lamp shade has an open end or two open ends.

4. The candle lamp of claim 1, wherein the lamp shade is transparent, translucent, or has smoke surfaces.

5. The candle lamp of claim 1, wherein the lamp shade has an outer surface formed with different patterns, floral traces and curved lines.

6. The candle lamp of claim 1, wherein the outer surface of the lamp shade is a convex surface, a concave surface, or a carved out surface with different patterns.

7. The candle lamp of claim 1, wherein the lamp shade has a shape mating the lamp holder which is formed as a candle and encases the outer surface of the lamp holder through a shrink molding process.

8. The candle lamp of claim 1, wherein the lamp shade is an integrated tube encasing the entire lamp holder.

9. The candle lamp of claim 1, wherein the lamp shade has an indented trough formed on the top end thereof for holding essence.
